(19) United States
(12) Patent Application Publication
(10) Pub. No.: US 2022/0307891 A1
(43) Pub. Date: Sep. 29, 2022

(54) LOAD SENSING FOR TRACTOR TRAILERS

(71) Applicant: SENSATA TECHNOLOGIES, INC., ATTLEBORO, MA (US)

(72) Inventors: ROBERT A. F. ZWIJZE, VRIEZENVEEN (NL); GERARD KLAASSE, APELDOORN (NL); CORBIN LOS, ENSCHEDE (NL); SIETSE HENDRIKS, ENSCHEDE (NL); DENNIS KAMPHUIS, HENGELO (NL); JOEL BROWN, BALLYMENA (GB)

(21) Appl. No.: 17/675,182

(22) Filed: Feb. 18, 2022

Related U.S. Application Data
(60) Provisional application No. 63/165,763, filed on Mar. 25, 2021.

(51) Int. Cl. G01G 19/02; B60G 17/019

(52) U.S. Cl. CPC G01G 19/028; B60G 17/01908; B60G 2400/0516; B60G 2400/60; B60Y 2200/147

(57) ABSTRACT

In a particular embodiment, a vehicle load measurement system is described that includes a chassis configured to support a body of the vehicle. In this embodiment, the vehicle load measurement system also includes a suspension system and a plurality of angle sensors attached to the suspension system. Each angle sensor is configured to measure an angle with respect to height. In this embodiment, the plurality of angle sensors include a first sensor attached to the first side of the suspension system configured to measure a first angle and a second sensor attached to the second side of the suspension system configured to measure a second angle. According to this embodiment, the first angle and the second angle are combined to obtain a combined value representative of axle load.

### CROSS-REFERENCE TO RELATED APPLICATIONS

This application claims priority to U.S. Provisional Application 63/165,763, filed Mar. 25, 2021, which is hereby incorporated by reference in its entirety.

### FIELD OF THE TECHNOLOGY

The subject disclosure relates to load sensing and vehicles, particularly to load sensing on tractor-trailer suspension systems.

### BACKGROUND

Large-scale tractor-trailer vehicles are designed to support heavy loads. In a tractor-trailer vehicle for example, freight is contained in a cargo area. The weight of the freight is distributed to a chassis of the vehicle. The weight and its distribution may affect operation of the vehicle so that monitoring the status of the suspension system and other components can provide valuable information, increase safety, and improve overall performance and reliability.

In some cases, sensors can be included to measure the vehicle load. However, installing sensors on an existing vehicle can be difficult. For example, strain sensors which can measure a vehicle load need to be integrated within the system and calibrated to determine a vehicle load and are not easy to add to an existing vehicle. Further, installing sensors can affect the mechanical structure of the vehicle, and therefore is not always possible.

### SUMMARY

Systems, apparatuses, computer program products, and methods of load sensing for tractor trailers with angle sensors are described. Unlike traditional load sensors, angle sensors may be installed on a vehicle suspension system without affecting the mechanical structure of the vehicle. As will be explained in further detail below, using data from angle sensors allows for a system to determine vehicle load without having installed sensors that affect the mechanical structure of the vehicle.

In a particular embodiment, a vehicle load measurement system is described that includes a chassis configured to support a body of the vehicle. In this embodiment, the vehicle load measurement system also includes a suspension system and a plurality of angle sensors attached to the suspension system. Each angle sensor is configured to measure an angle with respect to height. In this embodiment, the plurality of angle sensors include a first sensor attached to the first side of the suspension system configured to measure a first angle and a second sensor attached to the second side of the suspension system configured to measure a second angle. According to this embodiment, the first angle and the second angle are combined to obtain a combined value representative of axle load.

In another embodiment, load sensing for tractor trailers includes a method in which a first angle and a second angle are received from a plurality of angle sensors attached to a suspension system of a vehicle. In this embodiment, the method also includes calculating a value representative of axle load based on the first angle and the second angle.

### BRIEF DESCRIPTION OF THE DRAWINGS

FIG. 1A is a perspective view of an exemplary vehicle suspension system with angle sensors in accordance with the subject technology.

FIG. 1B is a perspective view of an exemplary vehicle suspension system with angle sensors in accordance with the subject technology.

FIG. 1C is a perspective view of an exemplary vehicle suspension system with angle sensors in accordance with the subject technology.

FIG. 2A is a graph of the relationship between height and the angle (α).

FIG. 2B is a graph of the relationship between height and the angle (β).

FIG. 2C is a graph of the relationship between height and the angle (θ).

FIG. 2D is a graph of the relationship between height and the angle (γ).

FIG. 2E is a table of the relationship between height and the angles (α), (θ), (β) and (γ).

FIG. 3 is a perspective view of a front steering axle suspension system showing the angle sensors (Ax) at different locations.

FIG. 4A is a graph of a relationship between angle and axle weight.

FIG. 4B is a graph plotting the error of sensor combination over various loads under test conditions.

FIG. 5 is a block diagram of an example system for load sensing for tractor trailers with angle sensors according to some embodiments.

FIG. 6 is a flowchart of an example method for load sensing for tractor trailers with angle sensors according to some embodiments.

### DETAILED DESCRIPTION

The subject technology relates to a vehicular load sensing system which determines a vehicle load by combining measured data from angle sensors. The angle sensors may be easy to install and may be attached to an existing suspension system using a simple clamp, for example. The load sensing system combines data from multiple sensors as related to height and obtains an accurate measurement of vehicle load based on the combined data. This can be particularly advantageous for tractor trailers where knowing the total vehicle load is important, and vehicle load can change significantly depending on the vehicle freight at a given time.

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows include implementations in which the first and second features are formed in direct contact, and also include implementations in which additional features be formed between the first and second features, such that the first and second features are not in direct contact. Further, spatially relative terms, such as “beneath,” “below,” “lower,” “above,” “upper,” “back,” “front,” “top,” “bottom,” and the like, are used herein for ease of description to describe one element or feature's relationship to another element(s) or feature(s) as illustrated in the figures. Similarly, terms such as “front surface” and “back surface” or “top surface” and “back surface” are used herein to more easily identify various components, and identify that those components are, for example, on opposing sides of another component. The spatially relative terms are intended to encompass different orientations of the device in use or operation in addition to the orientation depicted in the figures.

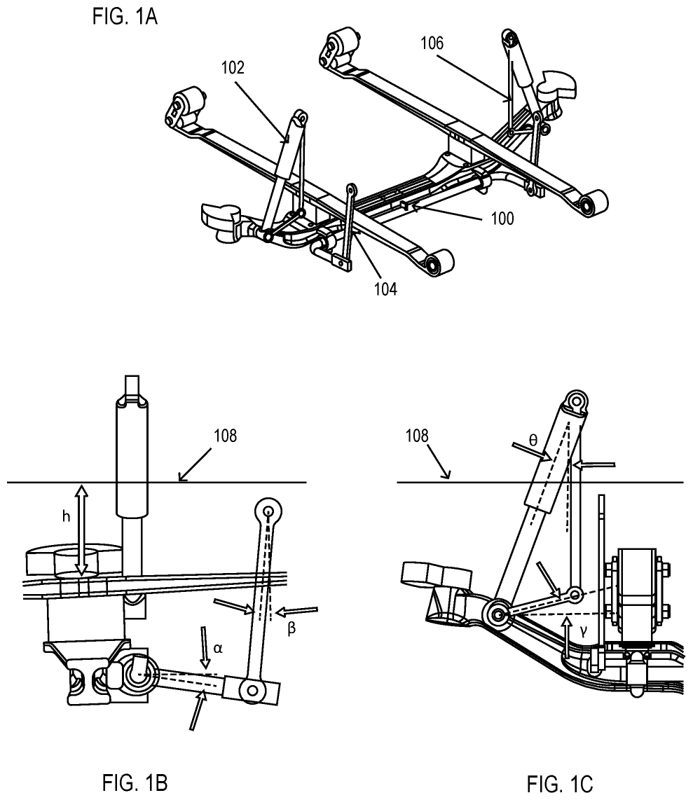

In load sensing for tractor and trailers, installation of sensors can have a significant impact on the mechanical structure of the vehicle, which can be undesirable for customers. The subject technology addresses many of the issues associated with load sensing on tractor-trailer trucks. In brief summary, the subject technology provides a load sensing system which combines data from multiple, easy to install angle sensors, to determine vehicle load. These angle sensors can be mounted to the torsion bar (α), shock absorbers (θ), swivel bar (β) or bracket (γ) as described in FIGS. 1A-1C. The advantages, and other features of the systems and methods disclosed herein, will become more readily apparent to those having ordinary skill in the art from the following detailed description of certain embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e., where an “upper” part must always be at a higher elevation).

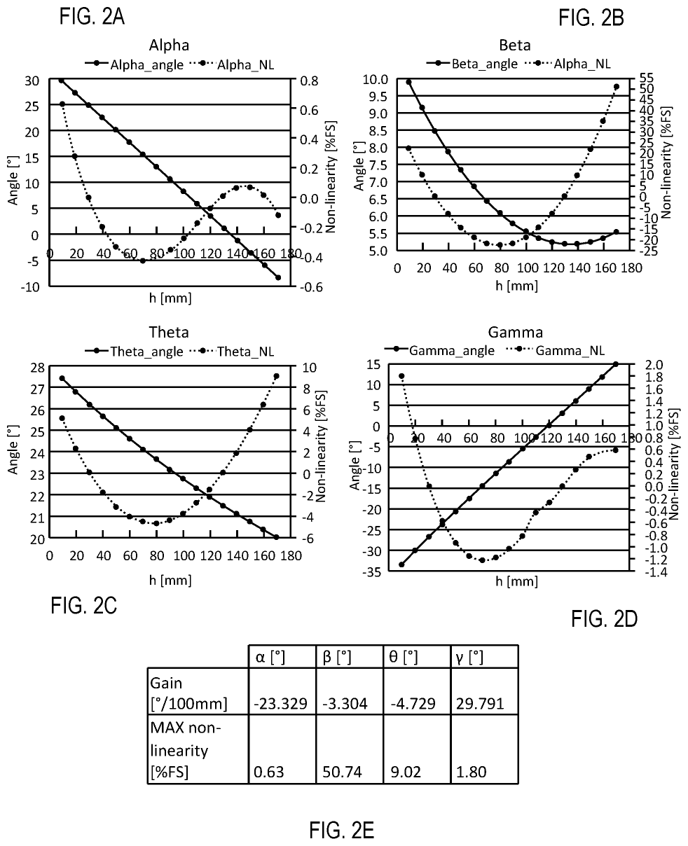

FIGS. 1A-1C show parts of an exemplary vehicle suspension system in accordance with the subject technology. The vehicle suspension system may be included as part of a tractor or otherwise part of a tractor-trailer suspension system. FIG. 1A illustrates an embodiment of the present disclosure detailing the location of angle sensors on a portion of a vehicle suspension system, including the torsion bar 100, the shock absorber 102, the swivel bar 104, and the bracket 106. An angle of the torsion bar is hereinafter denoted as (α). An angle of the shock absorber is hereinafter denoted as (θ). An angle of the swivel bar is hereinafter denoted as (β). An angle of the bracket is hereinafter denoted as (γ). In general, when a load is present on the vehicle suspension system, components of the suspension system will be placed under strain, causing some deflection from their unloaded position. The relationship between height (e.g., distance to a chassis 108 or displacement relative to the chassis 108) and particular angles is shown in FIGS. 2A-2E. As shown in FIGS. 2A-E, a particular measured angle indicates a particular height or displacement of a component or sensor relative to the chassis. The height or displacement relative to the chassis indicates a particular load causing the displacement.

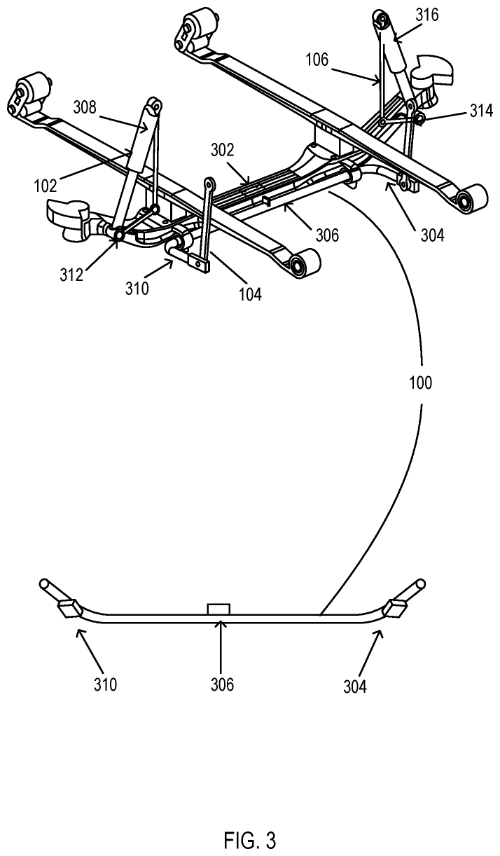

The front steering axle suspension of a truck is shown in FIG. 3 with angle sensors (Ax) located at different positions relative to the suspension. Sensor locations 302, 304, 306, 308, 310, 312, 314, and 316 indicate possible locations for fixing angle sensors. It is understood that, in some embodiments, various combinations of sensor placements are used. Moreover, one skilled in the art will appreciate that, in some embodiments, a sensor may be placed on the chassis (not shown) to measure the angle of the chassis relative to another component (e.g., the torsion bar 100, the shock absorber 102, the swivel bar 104, and the bracket 106). Sensors placed at sensor locations 308 and 316 are used to measure the shock absorber 102 angle (θ). Sensors placed at sensor locations 312 and 314 are used to measure the bracket angle (γ). Sensors placed at sensor locations 310 and 304 are used to measure the swivel bar 104 angle (β). Sensors placed at sensor locations 302 and 306 are used to measure the torsion bar 100 angle (α). One skilled in the art will appreciate that, in some embodiments, each angle (α), (β), (γ), and (θ) is measured by a pair of angle sensors at opposing sides of the suspension (e.g., sensor locations 308 and 316 are on shock absorbers 102 on opposing sides of the suspension.

While the angle sensors according to embodiments of FIGS. 1A-C & FIG. 3 are shown, it should be understood that this is by way of example only and different numbers of sensors could be included in different embodiments. In different embodiments, each sensor can be a standard angle sensor, as are known, configured in accordance with the teaching herein. Alternatively, in some embodiments, the sensors can be mechanically and/or electrically configured to include certain features. The sensors can be easily attached to the existing suspension system of a vehicle using simple fixation devices, such as via clamps, glues, or bolts.

The sensors can also include, or be connected to, the necessary electrical components to process, store, and transmit data processed by the sensors. Alternatively, the vehicle load measurement system can include a processor, memory for storing data, and a transceiver for sending and receiving data between the sensors. Output from the sensors and/or vehicle load measurement system can then be provided to a driver within the vehicle cabin, or to an external device, as desired.

Example equations used to determine axle load according to embodiments of the present disclosure are provided below for various types of sensing systems and as shown in FIG. 3. One skilled in the art will appreciate that, where a particular number is present (e.g., 308, 312, and the like), a measurement from an angle sensor at the corresponding numbered sensor location as described in FIG. 3 is used.

Torsion Bar Axle Load A=306−Chassis sensor

Torsion Bar Axle Load B=306−302

Torsion Bar Axle Load C=(304+310)−2*Chassis sensor

Torsion Bar Axle Load D=(304+310)−2*302

Shock Absorber Axle Load E=(308+316)−2*Chassis sensor

Shock Absorber Axle Load F=(308+316)−2*302

Bracket Axle Load G=(312+314)−2*Chassis sensor

Swivel Bar Axle Load H=(310+304)−2*Chassis sensor

Swivel Bar Axle Load I=(310+304)−2*302

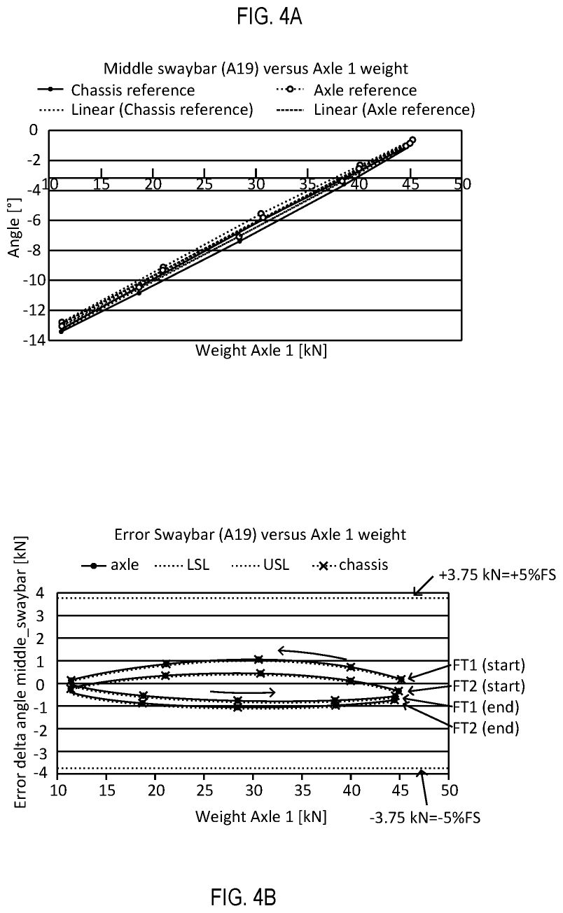

Referring now to FIG. 4A, the graph measurements are shown of system A and system B. In the graph of FIG. 4B, the error in kilonewtons (kN) is shown. The conclusion is that for the 75 kN axle, the signal is very linear and the error is well within the +/−5% limits.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

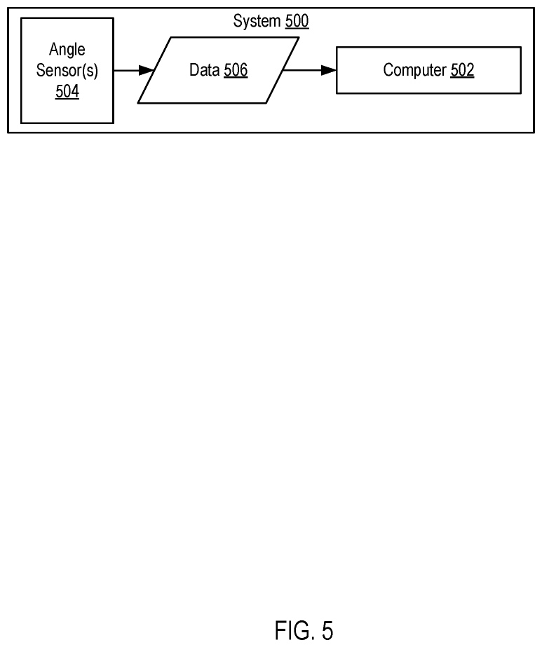

For further explanation, FIG. 5 shows an example system 500 for load sensing for tractor trailers with angle sensors according to some embodiments of the present disclosure. The example system 500 is implemented, for example, in a vehicle such as a tractor trailer. The system 500 includes a computer 502. The computer 502 is a computing device including functional components such as processors, memory, and the like. In some embodiments, the computer 502 includes an Engine Control Unit (ECU) or Vehicle Control Unit (VCU), or other component of the vehicle. In other embodiments, the computer 502 includes a dedicated computing device for load sensing for tractor trailers with angle sensors as can be appreciated. In some embodiments, the computer 502 is remotely disposed from a vehicle and is in communication with angle sensors 504 via a long range wireless network such as a cellular network or other network as can be appreciated.

The system 500 also includes angle sensors 504. The angle sensors 504 are configured to measure an angle of a particular component of a suspension such as the torsion bar 100, the shock absorber 102, the swivel bar 104, and the bracket 106. In some embodiments, the angle sensors 504 are fixed or deployed at various locations in the suspension, such as sensor locations 302, 304, 306, 308, 310, 312, 314, and 316.

The angle sensors 504 generate data 506 and provide the data 506 to the computer 502. In some embodiments, the data 506 indicates a particular angle measurement generated by the angle sensor 504. In some embodiments, the data 506 includes a height measurement calculated based on a measured angle. For example, an angle sensor 504 measures a particular angle and determines a corresponding height value based on a curve or other relationship between the measured angle and corresponding height, such as those shown in FIGS. 2A-E. Where the data 506 includes the measured angle, in some embodiments, the computer 502 calculates the corresponding height value.

The computer 502 receives the data 506 using one or more wired or wireless network connections. For example, in some embodiments, the angle sensors 504 are coupled to the computer 502 using one or more wired data connections. In some embodiments, the angle sensors 504 transmit the data 506 using one or more wireless networks, such as WiFi, Bluetooth, and the like. The computer 502 then calculates, based on the received data 506 (e.g., received height data or angle data), a value representative of axle load. The value representative of axle load may be calculated according to one or more of the equations described above, or variations thereof.

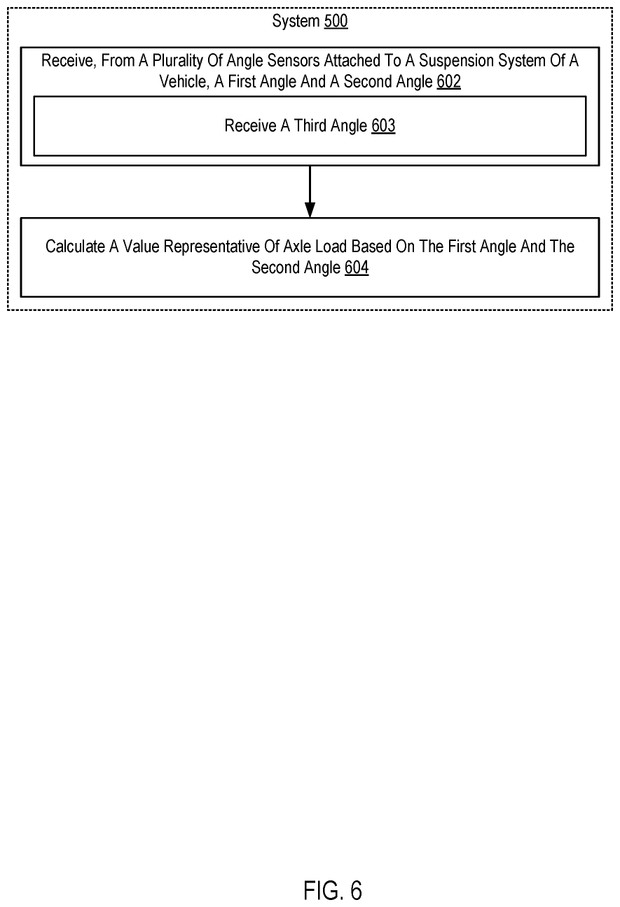

For further explanation, FIG. 6 shows an example method for load sensing for tractor trailers with angle sensors according to some embodiments of the present disclosure. The example method of FIG. 6 is implemented, for example, in a system 500 as described in FIG. 5. The method of FIG. 6 includes receiving 602, from a plurality of angle sensors 504 attached to a suspension system of a vehicle, a first angle and a second angle. The first angle and second angle may be indicated, for example, in data 506 received from a first angle sensor 504 and a second angle sensor 504, respectively. In some embodiments, the first angle and the second angle are received by a computer 502.

In some embodiments, the first angle and the second angle correspond to angles of particular suspension components located on opposing sides of the suspension. For example, in some embodiments, the angles correspond to angles of a torsion bar 100, a shock absorber 102, a swivel bar 104, or a bracket 106 on opposing sides of the suspension. In some embodiments, the method of FIG. 6 includes receiving 603 a third angle (e.g., from a third angle sensor).

The method of FIG. 6 also includes calculating 604 a value representative of axle load based on the first angle and the second angle. Where a third angle is received, the value is also calculated based on the third angle. The value representative of axle load may be calculated according to one or more equations depending on the particular angle sensors 504 from which the angles were received. In some embodiments, the value is calculated based on height values corresponding to the first angle and the second angle. For example, the height values are calculated using relationships between particular angles and height as shown in FIGS. 2A-E. In some embodiments, the value representative of axle load is calculated by a computer 504.

In view of the explanations set forth above, readers will recognize that the benefits of load sensing for tractor trailers with angle sensors include:
Improved performance of load sensing by providing for load sensing using angle sensors that do not significantly modify the mechanical structure of the vehicle.

Exemplary embodiments of the present disclosure are described largely in the context of a fully functional computer system for load sensing for tractor trailers with angle sensors. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

What is claimed is:

1. A vehicle load measurement system comprising:
a chassis configured to support a body of the vehicle;
a suspension system; and
a plurality of angle sensors attached to the suspension system, each angle sensor configured to measure an angle with respect to height, the plurality of angle sensors including a first sensor attached to the first side of the suspension system configured to measure a first angle and a second sensor attached to the second side of the suspension system configured to measure a second angle, wherein the first angle and the second angle are combined to obtain a combined value representative of axle load.

2. The vehicle load measurement system of claim 1, further comprising:
a computing device configured to:
receive the first angle and the second angle; and
calculate, based on the first angle and the second angle, the combined value representative of axle load.

3. The vehicle load measurement system of claim 1, wherein the plurality of angle sensors further include a third sensor configured to measure a third angle, and wherein the combined value representative of axle load is further based on the third angle.

4. The vehicle load measurement system of claim 1, wherein the first angle or the second angle comprises a torsion bar angle.

5. The vehicle load measurement system of claim 1, wherein the first angle or the second angle comprises a shock absorber angle.

6. The vehicle load measurement system of claim 1, wherein the first angle or the second angle comprises a swivel bar angle.

7. The vehicle load measurement system of claim 1, wherein the first angle or the second angle comprises a bracket angle.

8. A method of load sensing for tractor trailers with angle sensors, the method comprising:
receiving, from a plurality of angle sensors attached to a suspension system of a vehicle, a first angle and a second angle; and
calculating a value representative of axle load based on the first angle and the second angle.

9. The method of claim 8, further comprising:
receiving a third angle; and
wherein the value representative of axle load is further based on the third angle.

10. The method of claim 8, wherein the first angle and the second angle are each measured with respect to height.

11. The method of claim 8, wherein the first angle or the second angle comprises a torsion bar angle.

12. The method of claim 8, wherein the first angle or the second angle comprises a shock absorber angle.

13. The method of claim 8, wherein the first angle or the second angle comprises a swivel bar angle.

14. The method of claim 8, wherein the first angle or the second angle comprises a bracket angle.

15. A computer program product disposed upon a non-transitory computer readable medium, the computer program product comprising computer program instructions for load sensing for tractor trailers with angle sensors that, when executed, cause a computer system to perform steps comprising:
receiving, from a plurality of angle systems attached to a suspension system of a vehicle, a first angle and a second angle, wherein the first angle and the second angle are each measured respect to height; and
calculating a value representative of axle load based on the first angle and the second angle.

16. The computer program product of claim 15, further comprising computer program instructions that when executed, cause the computer system to perform the step of:
receiving a third angle; and
wherein the value representative of axle load is further based on the third angle.

17. The computer program product of claim 15, wherein the first angle or the second angle comprises a torsion bar angle.

18. The computer program product of claim 15, wherein the first angle or the second angle comprises a shock absorber angle.

19. The computer program product of claim 15, wherein the first angle or the second angle comprises a swivel bar angle.

20. The computer program product of claim 15, wherein the first angle or the second angle comprises a bracket angle.
